(19) United States
(12) Patent Application Publication
(10) Pub. No.: US 2010/0017802 A1
(43) Pub. Date: Jan. 21, 2010

(54) NETWORK SYSTEM AND METHOD FOR CONTROLLING ADDRESS SPACES EXISTING IN PARALLEL

(76) Inventor: Carsten Lojewski, Kaiserslautern (DE)

Correspondence Address: JACOBSON HOLMAN PLLC, 400 SEVENTH STREET N.W., SUITE 600, WASHINGTON, DC, 20004, US

(21) Appl. No.: 12/309,270

(22) PCT Filed: Jul. 16, 2007
(86) PCT No.: PCT/EP2007/006297

§ 371 Date: May 28, 2009

(30) Foreign Application Priority Data
Jul. 14, 2006 (DE) 10 2006 032 832.9

(51) Int. Cl. G06F 9/455; G06F 12/10

(52) U.S. Cl. 718/1

(57) ABSTRACT

The present invention relates to a network system having a large number of network elements which are connected via network connections and also to a method for controlling address spaces which exist in parallel. Network systems and methods of this type are required in order to organise distributed memories in an efficient manner which are connected via network connections, in particular in order to accelerate the memory access in the case of parallel distributed computing.

The present invention relates to a network system having a large number of network elements which are connected via network connections and also to a method for controlling address spaces which exist in parallel. Network systems and methods of this type are required in order to organise distributed memories in an efficient manner which are connected via network connections, in particular in order to accelerate memory access in the case of computing in a parallel distributed manner.

The present invention relates in particular to access control to distributed memories, in particular by means of applications which run in parallel (applications distributed in parallel in which applications on a plurality of separate units, such as e.g. PCs, are operated in parallel) and thereby to the uniting of these distributed memories in order to make them available efficiently to applications by remote direct memory access (RDMA).

There are understood as virtual memories or virtual memory addresses, memories which are addressed under an abstracted address. A virtual address is in this respect an abstracted address which can differ from the hardware-side physical address of the memory site. Furthermore, there is understood by an address region in the present application, address information comprising the address of the first memory site to be addressed in conjunction with the length (number of bits or bytes or the like) of the memory to be addressed.

There is understood in the following by the term of a linear address space, mapping to a memory region which can be addressed from a defined start address in a linear manner by means of various offsets (beginning from the start address with offset equal to zero).

There is understood in the following by a machine, an element which comprises a program part (software) and a hardware part (fixed circuitry or wiring), said element undertaking a specific task. Such a machine acts, when regarded as a whole, as a commercial machine and hence represents implementation of a commercial machine which includes a software component. An instance of a machine of this type (which likewise comprises a program part and a hardware part) is a unit or a component which implements or undertakes a specific task locally (in one network element).

Furthermore, it is assumed in the following that access to individual, local or remote memory sites is effected fundamentally on the basis of locally calculated addresses.

Progress in the field of network technology makes it possible nowadays to address also remote memory regions, for example memory regions connected via network connections with broad bandwidths. Network elements which already have a direct memory access (DMA) capacity are already known from the state of the art. They use for example PC extension cards (interfaces) which can read and write local or remote memory regions via direct memory access hardware (DMA hardware). This data exchange is effected on one side, i.e. without additional exchange of address information.

Consequently, it is basically possible to combine individual computer units, e.g. individual personal computers (PC), for example also with a plurality of multicore processors to form an efficient parallel computer. In such a case, this is described as a weakly coupled, distributed memory topology (distributed memory system) since the remote memory regions are linked to each other merely via network connections instead of via conventional bus connections.

In such a case of a weakly coupled distributed memory topology, it is necessary to impose a communication network thereon which firstly enables a data exchange between the communication partners.

According to the state of the art, the entire hardware of a computing unit is virtualised for this purpose by the operating system and made available to an application via software interfaces. The access of an application to one such local, virtualised memory and the conversion associated therewith is normally effected by the operating system. If an application wishes to access a remote memory region (reading or writing), then this is achieved by communication libraries, i.e. via special communication memories.

The access of a computing unit A to a computing unit B or the memories thereof is thereby effected always via a multistage communication protocol:

Firstly, the computing unit A informs the computing unit B that data are to be communicated. Then the computing unit A temporarily allocates a communication memory VA and copies the data to be communicated into this memory. Then the size of the memory which is required is transmitted by the computing unit A to the computing unit B. Hereupon, the computing unit B temporarily allocates a communication memory VB with this required size. Thereupon, the computing unit B informs the computing unit A that the temporarily allocated memory is available. Subsequently the data exchange is effected. After completion of the data exchange and completion of the use of the communicated data, the temporarily allocated memory regions are again made available.

As can be detected, such a procedure requires a large number of communication connections and coordinations between the computing units involved. Memory access of this type can be implemented thereby merely between individual communication pairs of respectively two computing units. Furthermore, it is disadvantageous that a complex communication library must be made available and that, for each communication to be effected, communication memories VA and VB must again be made available temporarily. Finally, it is disadvantageous that the arithmetic units of the computing units are themselves involved in the data exchange (e.g. copying process of the data used into the temporary communication buffer).

The present invention, which has the object of making available a network system and a method with which distributed memories can be accessed in a more efficient, flexible and better scalable manner in order to be able to implement for example a parallel application on a plurality of distributed network units, now begins here. There is hereby described by a parallel application, the entirety of all temporally parallel-running computing programs with an implementation path(s) which can be used together, connected via a network, for processing input data. The individual computing programs are thereby implemented with a separate memory on physically separated arithmetic units (arithmetic units of the network element). This is therefore also called parallel applications on distributed memories (distributed memory computing).

This object is achieved, in the case of the present invention, by the network system according to claim 1 and the method according to claim 21. Advantageous developments of the network system according to the invention and of the method according to the invention are indicated in the respective dependent claims. The invention relates furthermore to uses of network systems and methods of this type as are given in claim 23.

The crucial concept in the case of the invention is that, for efficient and consistent organisation of the access of an application to distributed memories in distributed network elements, a priori (i.e. at the latest at the start of the application or directly thereafter) in each of the involved network elements, at least a part of the physical system memory which is normally available for calculations is reserved permanently (i.e. over the entire running time of this application) for the data exchange with other network elements exclusively for this application. There is thereby understood by an exclusive reservation of a local physical memory region for the application that this local memory region is separated such that it is henceforth available exclusively to the mentioned application, in that thus other applications and the operating system are no longer able to have and/or acquire access rights to this physical memory region.

The memory regions which are reserved locally in the individual network elements are, as described subsequently in more detail, combined in one globally permanently usable physical communication- and computing memory in that the individual network elements exchange amongst each other information (e.g. start address and length of the reserved region or address region) via the physical memory regions which are reserved locally for identification. Exchanging amongst each other hereby means that each involved network element undertakes such an information exchange with every other involved network element (in general all network elements of the network system are hereby involved). Based on this exchanged information, a global virtual address space (global VM memory region) is spanned in that the global virtual addresses of this address space are structured such that each global virtual address comprises information which unequivocally establishes a network element (e.g. number of the network element) and information which unequivocally establishes a physical memory address located on this network element (e.g. the address information of the physical memory site itself.

This global VM memory region can then be used by the application for direct communication (direct data exchange between the network elements, i.e. without further address conversions virtually to physically) by means of DMA hardware in that the application uses the global virtual addresses as access addresses. The application hence uses global virtual addresses for a DMA call-up: this is made possible in that the global VM memory region is inserted into the virtual address space of the application (this is the virtual address space which is made available to the application by the operating system). The manner in which such insertion can take place is known to the person skilled in the art (e.g. MMAP). The direct DMA call-up by the application is hereby possible since a direct linear correlation exists between the inserted global VM memory region and the individual locally reserved physical memory regions. The application is hereby managed in addition in a standard manner by the operating system and can take advantage of the services of the operating system.

The physical system memory of a network element which is locally made available can thereby comprise for example a memory which can be addressed via a system bus of the network element (e.g. PC), however it is also possible that this physical system memory comprises a memory (card memory) which is made available on a separate card (e.g. PCI-E insert card).

In order to achieve the above-described solution, a common virtual machine is installed on the network elements which are involved. This comprises, on the network elements, program parts (software) and hardwired parts (hardware) and implements the subsequently described functions.

The virtual machine thereby comprises a large number of instances (local program portions and local hardware elements), one instance, the so-called VM instance which has then respectively a program part (local VM interface library) and a hardware part (local VM hardware interface), being installed in each network element. In the local memory of the respective network element, the VM instance allocates the above-described local physical memory region to be reserved, which region is made available to the virtual machine (and via this to the application) after exchange of the above-described information in the form of the global VM memory region. The allocation can thereby be undertaken either by the local VM interface library at the running time of the application or undertaken by the local VM hardware interface at the start time of the system or during the boot process. The global virtual addresses are unequivocal for each of the memory sites within the global VM memory region. Via such a global virtual VM address, any arbitrary memory site within the global VM memory region can then be addressed unequivocally by each of the VM instances as long as corresponding access rights were granted in advance to this instance. The local VM instances hence together form, possibly together with local and global operations (for example common global atomic counters), the virtual machine. This is therefore the combining of all VM instances.

Hence by means of the present invention, two address spaces are configured which exist in parallel and are independent of each other: a first address space which is managed as before by the operating system, and a further, second address space which is managed by the local VM instances. The second address space is made available exclusively to one application (if necessary also a plurality of applications) with the help of the local VM instances.

It is particularly advantageous if the individual VM instances exchange the information (e.g. start address and length of the reserved region) which are to be exchanged amongst each other by the individual network elements via the locally reserved physical memory regions directly after the system or during the boot process since, at this time, linearly connected physical memory regions of maximum size can be reserved in the respective local network element or access can be withdrawn by the operating system.

There are thereby possible as network elements computing units which have a separate arithmetic unit and also an assigned memory (e.g. PCs). However, because of technological development, memory units are also possible which are coupled to each other via network connections, for example internet connections or other LAN connections or even WLAN connections, said memory units not having their own computing units in the actual sense. It is possible because of technological development that the memory unit itself actually has the required microprocessor capacity for installation of a VM instance or that a VM instance of this type can be installed in an RDMA interface (network card with remote direct memory access).

The virtual machine optimises the data communication and also monitors the processes of the individual instances which run in parallel. Upon access of a parallel application (which is implemented on all local network elements) to the global VM memory region by means of DMA call-up, the required source- and target addresses are calculated by the associated local VM instance (this is the VM instance of that network element in which the application initiates a data exchange) as follows:

The (global virtual) source address is produced according to the address translation which was defined or was produced by inserting the global VM memory region into the virtual address space of the application from a simple offset calculation (the offset is hereby equal to the difference from the start address of the local physical region and the start address of the associated inserted region; first type of offset calculation).

If the (global virtual) target address is now accessed by the (local) VM instance, then the instance firstly checks whether the target address lies within the separate (local) network element. If this is the case, the target address is calculated by the VM instance analogously to the source address (see above). Otherwise, if for instance the number of the network element does not correspond to the number of the network element of the accessing VM instance, the target address is likewise produced from an offset calculation, here the offset then producing however, from the difference of the start addresses of the reserved physical memory regions of the local network element and of the relevant remote network element, the second type of offset calculation (i.e. access is effected via the global virtual address to the local physical memory region of the relevant remote network unit; the relevant remote network unit is thereby that network element which is established by the information contained in the corresponding global VM address for identification of the associated network element, i.e. for example the number of the network element). Subsequently, the data exchange is effected in both cases by means of hardware-parallel DMA.

It is particularly advantageous if the global virtual address is a 2-tuple, which has, as first information element, e.g. the worldwide unequivocal MAC address of the network element in which the memory is physically allocated, and, as second information element, a physical memory address within this network element. As a result, direct access of each VM instance to a defined memory site is possible within the global virtual address space.

Advantageously, it is also possible to define a separate global cache memory region which is controlled by the parallel application. This can take place as follows: firstly, one of the network elements involved is selected as cache network element. In this selected cache network element, the local physical memory is indicated separately as global LBU cache memory (LBU from load balancing unit; such an LBU is a quantity of operands or contents or data to be processed which, as is known to the person skilled in the art, describes a reduction of the problem, which is to be solved in parallel, of the parallel application into a plurality of individual, globally unequivocal sections (the units) which are assigned to the individual network elements for processing; the contents of the LBUs are thereby unchanging). The cache network element informs all other network elements of its property of being the cache network element (and also its network element number), by means of a service made available by the virtual machine (global operation).

In the cache network element, a protocol is stored in the global LBU memory, in which protocol it is noted which LBUs are currently located on which network elements. The protocol hereby notes for all LBUs in which network element they are located at that moment and where they are stored there in the local physical memory. For this purpose, the protocol is updated via the running time respectively, when an LBU is or has been communicated between two network elements in that the network elements involved inform the cache network element of this. Each LBU communication is hence retained in the protocol. The protocol can for example be produced in the form of an n-times associative table in which each table entry comprises the following information: global unequivocal LBU number, number of the network element on which the associated LBU is stored at that moment and physical memory address at which the LBU is stored in the physical memory of the network element. Since the cache network element functions precisely as a central instance with a globally unequivocally defined protocol, a global cache coherence can consequently be achieved easily.

If now the application of a network element wishes to access an LBU, it enquires firstly at the cache network element whether the number of the requested LBU is already located in the protocol (e.g. i.e. this LBU has been loaded recently by one of the network elements from its local hard disc into the reserved local physical memory), i.e. can be accessed via the reserved physical memory of the local network element or one of the remote network elements.

Hence, as described above, it is possible according to the invention to configure a global cache memory region. Should hence an application wish to access data which are not present locally but which are present according to the table managed by the cache network element in the reserved physical memory of a remote network element, then this data can be accessed efficiently in the above-described manner since the data are present in the global VM memory region, i.e. a DMA access to these data can be effected (which for example avoids local or remote disc access). Global validity of cache data can hence be ensured by the cache network element. In total, accelerated access to the data stored in the global virtual address space is consequently possible.

In the case of computing units as network elements, an instance of the virtual machine is therefore started on each of the computing units. This then divides the main memory present in a network element into two separate address regions. These regions correspond to the one locally reserved physical memory region of the virtual machine which region is made available exclusively to the global virtual memory region, and also to the remaining local physical memory which is managed furthermore by the operating system. The division can be effected quickly at the system start, be effected in a controlled manner via an application at the running time thereof or also be prescribed by the operating system itself.

Access rights for the global virtual VM memory region and/or the optional VM cache can thereby be allocated globally for each VM instance. Access to these memory regions can be made possible for example for each VM instance or only a part of the VM instances.

For example, directly after the start of the VM machine, all involved VM instances exchange information about their local address regions which are reserved for the global VM memory (e.g. by means of multicast or broadcast). Hence, in each network element, an LUT structure (look up table structure) can be produced locally, with the help of which the remote global virtual addresses can be calculated efficiently. The conversion of the local physical addresses into or from global virtual VM addresses (see description above for calculation of source- and target level) is thereby effected within the local VM instances.

Advantageously, the following productions of the conversions are thereby possible:
Direct implementation of the address conversion on the hardware of the DMA-capable network interface (e.g. by means of the above-described look up table LUT)
As software macro within a high-level language.

Advantageous in the present invention is in particular the use of a plurality (two) of different address spaces. The first address space corresponds thereby to the global VM memory region in a system with distributed memories, on which DMA operations of parallel applications can be implemented efficiently. The second address space thereby corresponds to an address space which exists in parallel to the VM memory region and independently thereof, which address space is managed by the local operating systems and which hence represents a memory model as in the case of cluster computing (distributed memory computing).

Hence a one-sided, globally asynchronous communication without communication partners (single side communication) becomes possible. Furthermore, the communication can be effected as global zero copy communication since no intermediate copies require to be produced for communication buffers. The arithmetic units of the computing units of the network elements are free for calculation tasks during the communication.

An application-related global cache memory (LBU cache memory) managed centrally by precisely one cache network element can be made available as global usable service by the virtual machine. This enables efficient communication even in the case of application problems which demand a larger memory requirement than that made available by the global VM memory region.

The present invention is thereby usable in particular on parallel or non-parallel systems, in particular with a plurality of computing units which are connected to each other via networks for parallel or also non-parallel applications. However the use is also possible with a plurality of distributed memory units if each memory subsystem has a device which enables remote access to this memory. Also mixed systems, in which the operation does not take place in parallel but the memory is present distributed on various network elements, are suitable for application of the present invention.

A few examples of network systems and methods according to the invention are provided in the following.

There are shown

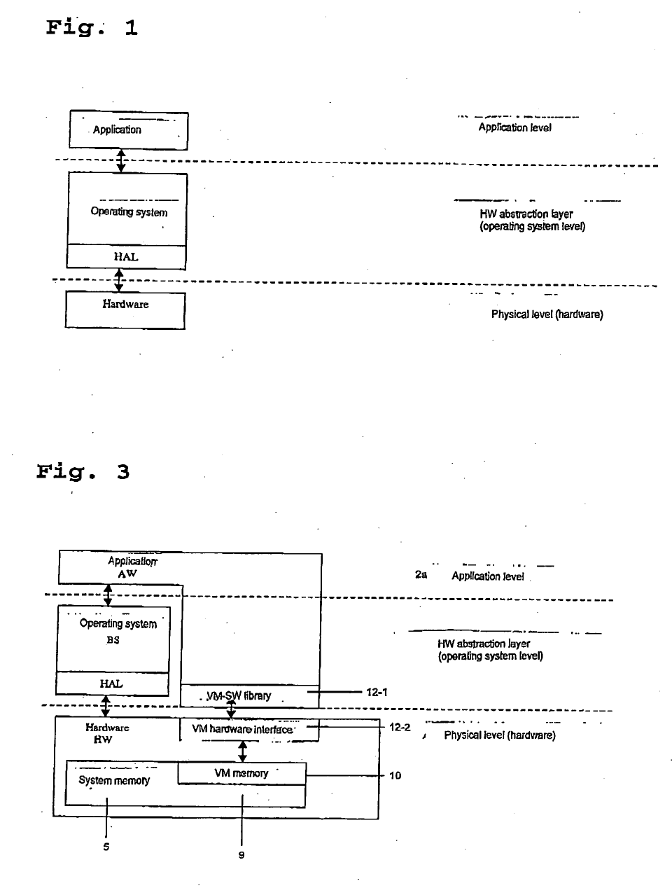

FIG. 1 a conservative system architecture;

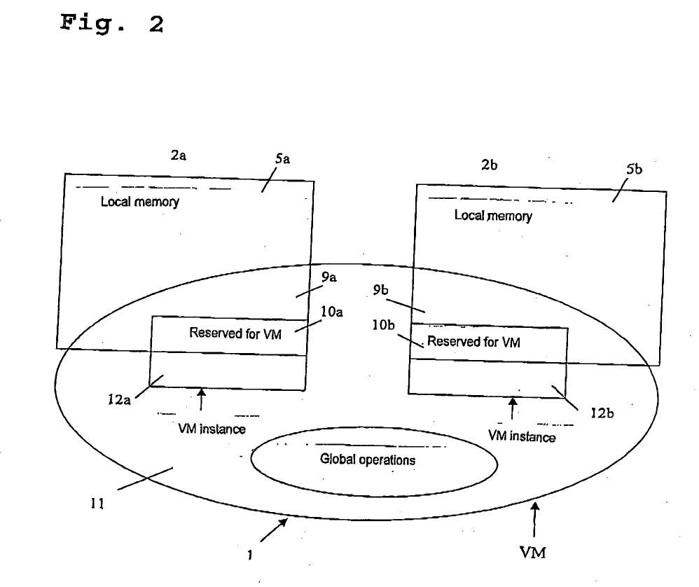

FIG. 2 the logical structure of a network structure according to the invention with two network elements 2a and 2b;

FIG. 3 the individual levels of a network system according to the invention;

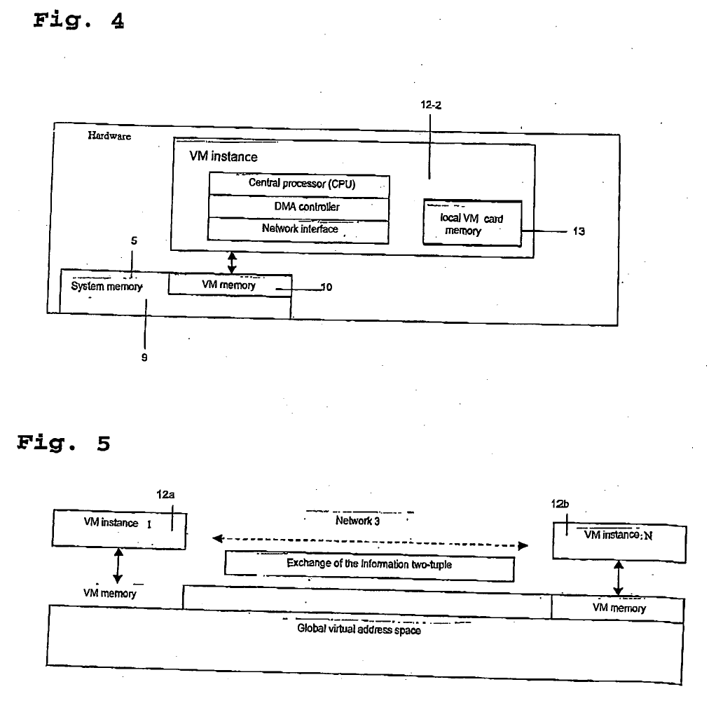

FIG. 4 the structure of the hardware interface of a VM instance;

FIG. 5 the global virtual address space or the global VM memory region;

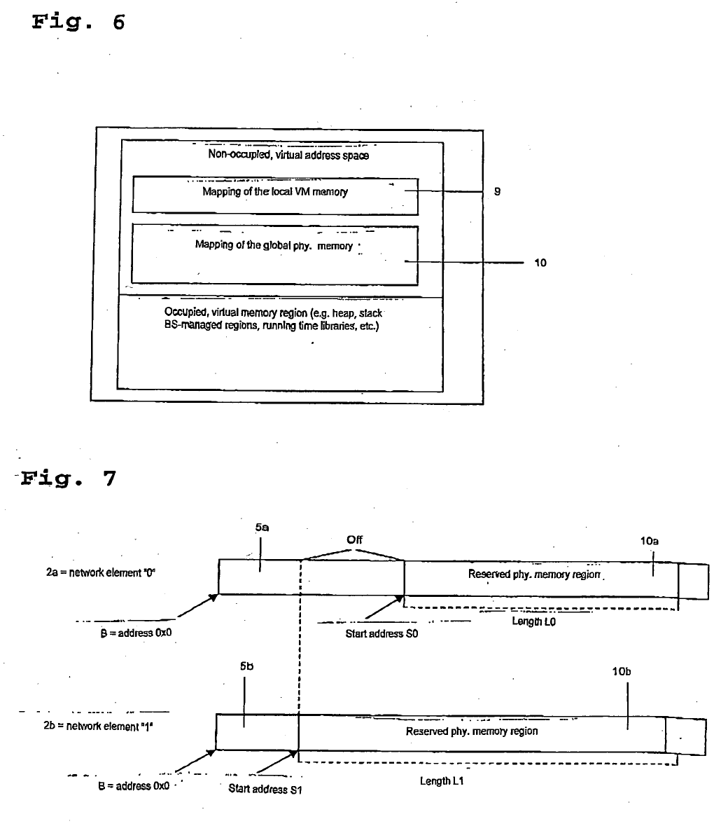

FIG. 6 the address space of a parallel application;

FIG. 7 the memory allocation in two network elements and also the offset calculation for calculating a target address for a DMA access.

Identical or similar reference numbers are used here as in the following for identical or similar elements so that the description thereof is possibly not repeated. In the following, individual aspects of the invention are portrayed in connection with each other even if each individual one of the subsequently portrayed aspects of the examples and of the invention represent as such developments per se according to the invention of the present invention.

FIG. 1 shows a conservative system architecture, as is known from the state of the art. The Figure shows how, in conventional systems, an application (for example even a parallel application) can access hardware (for example a physical memory). As shown in FIG. 1, there are configured for this purpose, for example in a network element, in general three different levels (represented here one above the other vertically). The two upper levels, the application level on which the for example parallel application runs and also the operating system level or hardware abstraction layer situated therebelow, are produced as software solution. The physical level on which all the hardware components are located is located below the operating system level. As shown, the application can hence access the hardware via the operating system or the services made available by the operating system. For this purpose, a hardware abstraction layer (HAL) is provided in the operating system level (for example drivers or the like), via which the operating system can access the physical level or hardware level, i.e. for example can write calculated data of the application into a physical memory.

FIG. 2 now shows the basic structure of a network system according to the present invention. This has two network elements 2a, 2b in the form of computing units (PCs) which respectively have a local physical memory 5a and 5b. By means of the instance of the virtual machine which is installed respectively on the network element, a part 10a, 10b of this local memory is reserved for the global use by means of the virtual machine as global virtual memory region. Subsequently, the reference number 10 is used alternatively for a physical memory which is separated by a VM instance or for the part of the global virtual memory region which corresponds to this memory. From the context, it can thereby be recognised by the person skilled in the art what is respectively intended. The instances of the virtual machine which are installed on the respective computing units and designated with the reference numbers 12a and 12b manage this memory 10a, 10b. The physical memory 5 is therefore divided into local memory 9a, 9b which is managed by the operating system and can be made available in addition to a specific application (and also to other applications), and global VM memory 10a, 10b, which is made available exclusively to the specific (parallel) application and is no longer visible for to the operating system.

The totality of the reserved global memory region 10a, 10b, of the instances of the virtual machine 12a, 12b and also the global operations which are required for operating the machine and for optimising the memory use (e.g. barriers, collective operation etc.), form the virtual machine 11. This virtual machine is therefore a total system comprising reserved memory, programme components and/or hardware which form the VM instances 12a, 12b.

With a virtual machine 11 of this type within a network system 1, an overall global virtual memory region is consequently produced and managed, which is accessible for applications on one of the computing units and also for applications which run in parallel and distributed to the computing units.

The number of network elements or computing units can of course be generalised to an arbitrary number.

Each of the computing units 2a and 2b here has one or more arithmetic units in addition to the main memory 5a, 5b thereof. These arithmetic units cooperate with the main memory 5a. Each computing unit 2a, 2b here has in addition a DMA-capable interface at the hardware level. These interfaces are connected to a network via which all the computing units together can communicate with each other.

An instance of a virtual machine is now installed on each of these computing units 2a, 2b, the local VM instances, as described above, exclusively reserving the local physical memory, spanning the global VM memory and consequently enabling the DMA operations. The network is of course also DMA-capable since it then implements the data transport between the two computing units 2a and 2b via the DMA network interfaces of the network elements.

Advantageously, the DMA-capable network hereby has the following characteristic parameters:
the data exchange between the main memories is effected in a parallel hardware manner, i.e. the DMA controller and the network operate independently and are not programme-controlled;
access to the memories (reading/writing) is effected without intervention of the arithmetic units;
the data transport can be implemented asynchronously non-blocking;
the transmission is effected with a zero copy protocol (no copies of the transmitted data are applied) so that no local operating system-overhead is required.

In order to conceal the latency times of the network, parallel applications in the network system 1 can advantageously access the global VM memory region of the virtual machine asynchronously. The current state of the reading and writing operation can thereby be called up at any time by the virtual machine.

In the case of the described system, the access bandwidth to remote memory regions, i.e. for example by the computing unit 2a to the memory region b of the computing unit 2b is further increased in that, as described above, a global cache memory region is defined (e.g. the network element 2a is established as cache network element). The local VM instances hereby organise the necessary inquiries and/or accesses to the protocol in the cache network element. The global cache memory region is hence organised by the virtual machine. It can be organised for example also as FIFO (First In First Out) or as LRU (Least Recently Used) memory region in order to store requested data asynchronously in the interim. For this global cache memory, global memory consistency can be guaranteed, e.g. in that cache inputs are marked as “dirty” if a VM instance has changed this previously in write.

As a result, a further accelerated access to required data is achieved in total. The cache memory region is transparent for each of the applications which uses the virtual machine since it is managed and controlled by the virtual machine.

In the case of the example shown in FIG. 2, a part of the main memory 5a, 5b is available locally as usual as local memory in addition for all applications on the computing units 2a, 2b. This local memory is not visible for the virtual machine (separate address spaces) and consequently can be used locally elsewhere.

If an application accesses a memory address within the global memory region 10a, 10b via a VM instance, then the respective local VM instance 12a, 12b determines an associated communication-2-tuple as virtual address within the global VM memory region 10a, 10b. This 2-tuple is composed in this example of two information elements, the first element being produced from the network address (in particular worldwide unequivocal MAC address) of the local computing unit 2a, 2b and the second element from a physical address within the address space of this network element.

This 2-tuple therefore indicates whether the physical memory which is associated with the global virtual address is located within the computing unit itself on which the application runs and which wishes to access this memory region, or pertains to a remote memory region in a remote computing unit. If the associated physical address is present locally on the accessing computing unit, then this memory is accessed directly, as described above, according to the first type of offset calculation.

If however the target address is situated on remote computing units, for example on the computing unit 5b, then the local VM instance which is installed on the computing unit 5a implements the second type of offset calculation locally, as described above, and initiates a DMA call-up with the corresponding source- and target address. Calculation of the addresses on the remote computing unit 5b is hereby effected, as described subsequently in even more detail, via the 2-tuple of the global virtual address by means of access to a look-up table. After initiation of the DMA call-up, the control goes to the DMA hardware, in this case RDMA hardware. For further data transmission, the arithmetic units in the computing units 5 are then no longer involved and can assume other tasks, for example local applications or hardware-parallel calculations.

By means of the present invention, a machine with a distributed memory (shared memory machine) is therefore associated with the advantages of a distributed memory topology.

Also by simple replacement of the computing units 2a, 2b by memory units, the present invention can also be used in network systems in which individual memory units are connected to each other via network connections. These memory units need not be part of the computing units. It suffices if these memory units have devices which enable RDMA access to these memory units. This then also enables use of memory units coupled via network connections within one system in which possibly merely one computing unit is still present or in systems in which the virtual machine adopts merely the organisation of a plurality of distributed memory units.

FIG. 3 now shows the parallel address space architecture and the different levels (software level and hardware level), as they are configured in the present invention. For this purpose, the Figure shows an individual network element 2a which is configured as described above. Corresponding further network elements which are connected to the network element 2a via a network are then likewise configured (the parallel specific application AW which uses the global VM memory region via the virtual machine or the local VM instances runs on all network elements 2).

As described above, two separate address spaces which exist in parallel are now produced, a first address space (global VM memory region) which is inserted into the virtual address space of the application AW, and hence is available for the application as global virtual address space: the application AW (of course a plurality of applications can also hereby be of concern) can hence access the hardware of the physical level, i.e. the physical memory (designated here as VM memory 10) which is locally reserved for the global VM memory region via the global virtual addresses of the VM memory region directly, i.e. by means of DMA call-ups. As shown in FIG. 3 (right column), the individual application in this case operates with the help of the local VM instance on the operating system level and has exclusive access to the VM hardware, in particular therefore to the physical system memory 10 which is managed by the VM hardware.

In order to make this possible, the local VM instance 12 in the present case comprises a VM software library 12-1 on the operating system level and also a VM hardware interface 12-2 on the physical/hardware level. In parallel to the VM memory region or address space and separate therefrom, a further, second address space exists: the local address space. Whilst the VM address space is managed by the virtual machine or the local VM instance 12 and hence is not visible for the operating system BS and also for other applications which do not operate with the VM instances, this further, second address space is managed by the operating system BS in a standard manner. As in the case of the conservative system architecture (FIG. 1), the operating system BS can in addition make available the physical memory of the system memory 5, which corresponds to this second address space 9, via the hardware abstraction layer HAL of the specific application AW. The application hence has the possibility of accessing both separate address spaces. Other applications which are not organised via the virtual machine can however only access the system memory region 9 or the first address space via the operating system.

FIG. 4 now shows an example of a structure of the VM hardware interface 12-2 of FIG. 3. This hardware part of the VM instance 12 here comprises the components central processor, DMA controller, network interface and optional local card memory. The VM hardware interface unit 12-2 in the present case is produced as an insert card on a bus system (e.g. PCI, PCI-X PCI-E, AGP). The local card memory 13, which is optionally made available here in addition, can also, like the VM memory 10 (which is assigned here to the physical memory on the main board or the mother board), be made available to the application AW as part of the global VM memory region (the only difference between the local card memory 13 and the VM memory region 10 hence resides in the fact that the corresponding physical memory units are disposed on different physical elements). As an alternative to the production as insert card, the VM hardware interface 12-2 can also be produced as an independent system board. The VM hardware interface 12-2 is able to manage the system memory allocated to it independently.

FIG. 5 sketches the configuration of the global VM memory region or address space of the network system 1 according to the invention, which spans the various local network elements 2. In order to span this global memory region, the individual local VM instances in the individual network elements exchange information amongst each other before receiving any data communication. Exchanging amongst each other hereby implies that each network element 2 involved in the network system 1 via the VM instance 12 thereof exchanges the corresponding information with every other network element 2. The exchanged information in the present case is likewise coded as 2-tuple, the first element of the 2-tuple contains an unequivocal number for each network element 2 involved within the network system 1 (e.g. MAC address), of one PC connected via the internet to other network elements, the second element of the 2-tuple contains the start address and the length of the physical memory region reserved in this network element (or information relating to the corresponding address region). As described already, on the basis of this information exchanged in advance of any data communication, the global VM address space can be spanned, said VM address space then being usable for the DMA controller communication without additional address conversions. The global address space is made accessible to the locally running applications hereby by means of the respective local VM instance.

FIG. 6 sketches the insertion of the global VM memory region into the virtual address space of the specific application AW which is the prerequisite for using the global virtual addresses for a DMA call-up via a VM instance 12 by means of the application AW. FIG. 6 hence shows the address space of the application AW which via the respective VM software libraries 12-1 inserts or maps the address regions made available by the VM hardware interfaces 12-2 into the virtual address space thereof. The entire virtual address space of the application AW is hereby substantially larger, as normal, than the inserted global VM memory region. There is illustrated here in addition the local physical memory which can be used in addition by the application via the operating system BS and which was not reserved for the virtual machine (mapped local memory 9).

In addition to the address space, locally managed by the operating system BS (virtualisation of the remaining local physical system memory), a further address space which is hence completely separate therefrom exists as global VM memory region which is distributed over a plurality of VM instances (the latter then is usable for parallel DMA communication).

It is hereby crucial that the global virtual address space or global VM memory region of the application is available only after initialisation of the VM instances and the above-described exchange of information for the DMA communication. For this purpose, at least one partial region is separated locally by every involved VM instance 12 initially from the physical memory of the associated network element, i.e. is distinguished as exclusively reserved physical memory region. This allocation can thereby be undertaken either by the VM interface library 12-1 at the running time of the application or before this time already by means of the VM hardware interface 12-2 at the starting time of the system or during the boot process. If this reservation is effected, then the individual VM instances of the individual network elements then exchange amongst each other the necessary information (start address and length of the reserved region) via the locally reserved physical memory regions amongst each other. In this way, a memory allocation is produced, in the case of which a linear physical address space which can be used directly for DMA operations with source- and target address and data length, is assigned to the global VM memory region which can be used by the application AW. This address space can be addressed directly via a memory mapping (memory mapping in the virtual address space of the application) or via the VM instance from one application.

FIG. 7 now shows, with reference to the simple example of two network elements 2a and 2b how a locally physical memory for the global VM memory region is reserved in each of these network elements and how, in the case of subsequent memory access by the VM instance of a local network element (network element 2a) to a remote network element (network element 2b), the calculation of the target address is effected for the direct DMA call-up. The network element 2a and the network element 2b hereby make available respectively one physical memory region 5a, 5b (main memory). This begins respectively in the case of the physical start address B=“0x0”. In the network element 2a, the physical memory region or corresponding global VM memory region 10a is now made available (likewise the memory region 10b in element 2b). The region 10a hereby has the length L0 (length of the memory region 10b: L1). The physical memory regions 10a and 10b now begin with different physical start addresses S₀ (element 2a) and S₁ (element 2b). There is illustrated in addition the network element number “0” of element 2a and the network element number “1” of element 2b (these two numbers are mutually exchanged between the two network elements 2a and 2b as first information element of the information-2-tuple). If for example a global virtual address begins with “0”, then the VM instance of the network element 2a knows that the associated physical memory site can be found in this network element, if it begins with “1”, then the VM instance of the network element 2a knows that the associated physical memory site can be found in the remote network element 2b.

In the latter case, the target address for a DMA access of element 2a to the physical memory of element 2b is calculated as follows: by means of the exchanged information, the unit 2a knows about the difference in the physical start addresses S₀ and S₁. A simple offset calculation of the shift of these start addresses, i.e. Off=S₀−S₁, then enables, with the calculated offset Off, a direct DMA access of an application in the network element 2a via the associated VM instance to the memory of the network element 2b.

The offset Off is hence added simply to a (local) physical address which is normally addressed by an application upon access to a remote network element in order to access the correct physical memory site of the remote network element (linear mapping between the global VM region and the locally assigned physical memory regions).

Since it cannot be ensured that all network elements can reserve physical memories at corresponding start addresses S with the same length L, an exchange of this information amongst the network elements is necessary. An exchange by means of broadcast or multicast is effective here via the DMA network. Each network element can then jointly read the information of the other network elements within the VM and construct an LUT structure (see table), via which the spanned global address space can be addressed by simple local calculations (offset calculations).

| | |
|---|---|
| Network element | 2-tuple (Start address, Length) |

| number | Start address | Length |
|---|---|---|
| 0 | S0 | L0 |
| . | . | . |
| . | . | . |
| . | . | . |
| N | SN | LN |

1. Network system (1) having a plurality of network elements (2) which are connected via network connections (3),
each of the network elements having at least one physical memory (5) and also a DMA-capable network interface
and an instance (VM instance, 12) of a virtual machine (VM, 11) being configured or being able to be configured on each network element (2) such
that at least a part of the physical memory of the associated network element can be separated by means of each VM instance such that this part is no longer visible for an operating system (BS) which runs or can be run on this network element and that this part can be accessed exclusively via the virtual machine,
that after separation of all the memory regions, information relating to the memory regions which are locally separated respectively in the individual network elements can be exchanged by all VM instances amongst each other,
that after exchanging all the information based on the memory regions which are locally separated in the network elements, a global virtual memory region (VM memory region, 10) which spans the network elements can be configured, by the virtual machine, there being assigned to each memory site in the VM memory region a global virtual address which is uniform for all VM instances of the virtual machine and which is composed of information which unequivocally identifies that network element on which the associated physical memory address is located, and information which unequivocally identifies this physical memory site, and
that after configuration of the VM memory region by a locally running VM instance (12a) of one of the network elements (2a) upon access thereof to the global virtual address of a physical memory site which is located on a further, remote network element (2b), this physical address can be calculated on the remote network element (2b) and DMA access can be implemented with source- and target address to the separated physical memory region of the remote network element (2b) for exchange of data between the local network element (2a) and the remote network element (2b).

2. Network system (1) according to the preceding claim, characterised by at least one application which is configured or can be configured on at least one of the network elements, in particular a parallel application, for which the VM memory region is reserved or can be reserved exclusively as computing memory.

3. Network system (1) according to the preceding claim, characterised in that, with the application, by means of a locally running VM instance, DMA access to the physical memory of a remote network element can be implemented.

4. Network system (1) according to claim 2, characterised in that the global VM memory region is inserted or can be inserted into the virtual address space of the application.

5. Network system (1) according to claim 2, characterised in that, in at least one of the network elements, the part of the physical memory can be separated at the running time of the application.

6. Network system (1) according to claim 1, characterised in that, in at least one of the network elements, the part of the physical memory can be separated at the start time of the system or during the boot process.

7. Network system (1) according to claim 1, characterised in that, on at least one of the network elements separated from the address space part of the VM memory region, which address space part is configured or can be configured by means of the separated memory region, a further address space is configured or can be configured by means of at least one part of the unseparated part of the physical memory of this network element, which further address space can be managed by the operating system which is running or can run on this network element.

8. Network system (1) according to claim 1, characterised in that the information to be exchanged can be exchanged by the VM instances immediately after the system start or during the boot process.

9. Network system (1) according to one of the preceding claims, characterised in that the information to be exchanged comprises respectively the start address and the length of the respectively separated part of the physical memory.

10. Network system (1) according to claim 1, characterised in that at least one of the separated physical memory parts is configured or can be configured as a linear physical memory region.

11. Network system (1) according to claim 1, characterised in that precisely one of the network elements is configured or can be configured as cache network element in that a local physical memory region is identified or can be identified separately as global cache memory and in that, in this memory region, a protocol which can be accessed via the VM instances is stored or can be stored, in which protocol it is noted which LBUs (load balancing units) of a parallel application are located on which network elements.

12. Network system (1) according to claim 1, characterised in that the calculation of the physical address on the remote network element can be implemented by the local VM instance by means of an offset calculation.

13. Network system (1) according to the preceding claim, characterised in that the calculation is effected as software macro in a high-level language or by a look-up table, in particular by a software macro or by a look-up table in the DMA-capable network interface.

14. Network system (1) according to claim 1, characterised in that at least one of the VM instances is configured in the form of a software library and/or a hardware interface.

15. Network system (1) according to claim 1, characterised in that at least one VM instance, preferably each of the VM instances, has access rights to the VM memory region.

16. Network system (1) according to claim 1, characterised in that the global virtual address is a 2-tuple.

17. Network system (1) according to claim 1, characterised in that the global virtual addresses of all VM instances form a uniform global virtual address space.

18. Network system (1) according to claim 1, characterised in that the network elements (2) are memory units or computing units which have at least one arithmetic unit.

19. Network system (1) according to claim 1, characterised in that the transmission of data via the network connections (3) is effected at least partially asynchronously.

20. Network system (1) according to claim 1, characterised in that, upon requesting transmission of data from memory sites with a global virtual source address of a local network element (2) to memory sites with a global virtual target address, the VM instance (12) which runs on the local network element (2) determines the local physical source address from the global virtual source address and implements a local DMA call-up of
